(19) United States
(12) Patent Application Publication
(10) Pub. No.: US 2016/0172796 A1
(43) Pub. Date: Jun. 16, 2016

(54) SELF-ILLUMINATING UNIVERSAL SERIAL BUS SOCKET

(71) Applicant: John Christopher Humphreys, San Marcos, TX (US)

(72) Inventor: John Christopher Humphreys, San Marcos, TX (US)

(21) Appl. No.: 14/971,697

(22) Filed: Dec. 16, 2015

Related U.S. Application Data
(60) Provisional application No. 62/092,749, filed on Dec. 16, 2014.

(51) Int. Cl. H01R 13/717; H01R 13/64

(52) U.S. Cl. CPC H01R 13/7175; H01R 13/64

(57) ABSTRACT

A micro universal serial bus (USB) socket is disclosed which improves the invisibility of a micro USB port connection, especially in low light environments. The USB socket includes a light source, for example, a light emitting diode which is disposed to illuminate the periphery of the socket housing and around a set of USB connector pins in the socket. Some embodiments include a translucent or semi-transparent casing around the light source and proximate the set of USB connector pins which may be a light reactive polymer that produces photoluminescence when lit by the light source.

### CROSS-REFERENCE TO RELATED APPLICATIONS

This application claims benefit under 35 U.S.C. § 119(e) of U.S. Provisional Application having Ser. No. 62/092,749 filed Dec. 16, 2014, which is hereby incorporated by reference herein in its entirety.

### BACKGROUND

The embodiments herein relate generally to electrical connections, and more particularly, to a self-illuminating micro universal serial bus (USB) socket.

Conventional USB ports are typically in dark casings and include dark interiors. It is common for users to make several attempts to connect to a USB port because the male or female socket is difficult to make out. As is known, micro USB sockets are designed for connection in one orientation. Sometimes users make one attempt and if unsuccessful, flip the plug around and make another attempt unsuccessfully. This may be particularly true in low light environments because the user cannot see the internal orientation of the target port. The user may believe that they are not connecting because they have the incorrect orientation but in fact are mistaken and are merely misaligning the male opening with the female opening because of poor visibility. In some instances, repeated attempts to connect may damage the USB connector pins or their substrate.

As can be seen, there is a need for a USB port that improves the visibility during connection.

### SUMMARY

According to one embodiment, a micro universal serial bus (USB) socket comprises a socket housing configured to fit within a USB port; a set of USB connector pins mounted to the socket housing; a light source coupled to the socket housing and disposed to project light around a periphery of the set of USB connector pins; and an electrical lead connected to the light source, the electrical lead for connection to a power source.

According to another embodiment, a USB socket comprises a female socket housing configured to fit within a USB port; a set of USB connector pins mounted to the female socket housing; an LED coupled to the female socket housing and disposed to project light around a periphery of the set of USB connector pins; a translucent or transparent light reactive polymer casing encasing the LED, wherein the casing projects toward an entry of the socket housing and is positioned at least partially above and partially below the set of USB connector pins; and an electrical lead connected to the LED and connected to a pin-out of the set of USB connector pins, the electrical lead for connection to a power source

### BRIEF DESCRIPTION OF THE FIGURES

The detailed description of some embodiments of the present invention is made below with reference to the accompanying figures, wherein like numerals represent corresponding parts of the figures.

FIG. 1 is a perspective top view of a micro USB port and socket in use in accordance with an exemplary embodiment of the subject technology;

FIG. 2 is a cross-sectional side view of the socket of FIG. 1 taken along the line 2-2;

FIG. 3 is a perspective front view of the micro USB socket of FIG. 1 removed from the port; and

FIG. 4 is a perspective rear view of the micro USB socket of FIG. 3.

### DETAILED DESCRIPTION OF CERTAIN EMBODIMENTS

The word “exemplary” is used herein to mean “serving as an example or illustration.” Any aspect or design described herein as “exemplary” is not necessarily to be construed as preferred or advantageous over other aspects or designs.

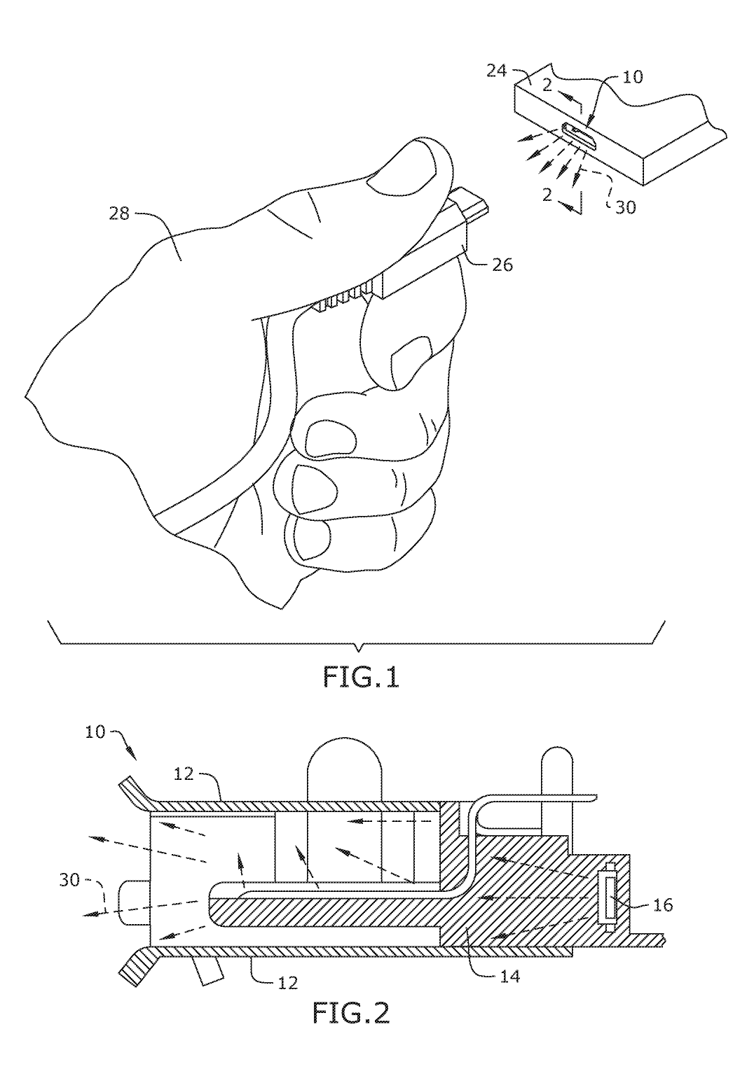

Generally, embodiments of the subject technology provide illuminated universal serial bus (USB) ports at the socket. Illumination may be either at the male or female end of a port connection however for sake of illustration, embodiments are shown with the female end illuminated for clarity of the aspects disclosed. Referring to FIG. 1, a USB socket 10 is shown according to an exemplary embodiment. When a user 28 wishes to connect for example a male USB plug 26 into for example, a female USB port 24, light 30 illuminates the periphery of the socket 10 and internal pins of the socket 10 are visible in low light settings. Thus the USB plug 26 may be aimed at the USB socket 10 of the present invention with higher accuracy unlike current USB sockets whose outline are difficult to gauge causing the user to miss and fumble with the connection.

Referring to FIGS. 2-4, the internal features of the female USB port 24 are shown according to exemplary embodiments. The USB socket 10 may include a socket housing 12 configured to fit within the USB port 24. A set of USB connector pins is mounted to the socket housing 12 as is known in the art with access to the connector pins being provided from a front opening in the socket housing 12. The USB connector pins may be mounted onto a chip or printed circuit board with electrical leads extending rearward in a direction opposite the front opening. A light source 16 is coupled to the socket housing 12 and disposed to project light around a periphery of the set of USB connector pins. In an exemplary embodiment, the light source 16 is a light emitting diode (LED). An electrical lead from the light source 16 may be connected to a power source of the electrical device host (not shown) in which USB port 24 is mounted. Some embodiments may connect the electrical lead to a pin-out 18 of the set of USB connector pins which may be on a shared power line connecting the USB port 24 to the electrical device host's (not shown) power source. Another electrical lead from the light source 16 may be connected to a ground pin 20 on a shared grounded line of the electrical device host (not shown). Once powered, the light source 16 may illuminate from the rear of, and around the set of USB connector pins outward toward the entry opening of the socket housing 12.

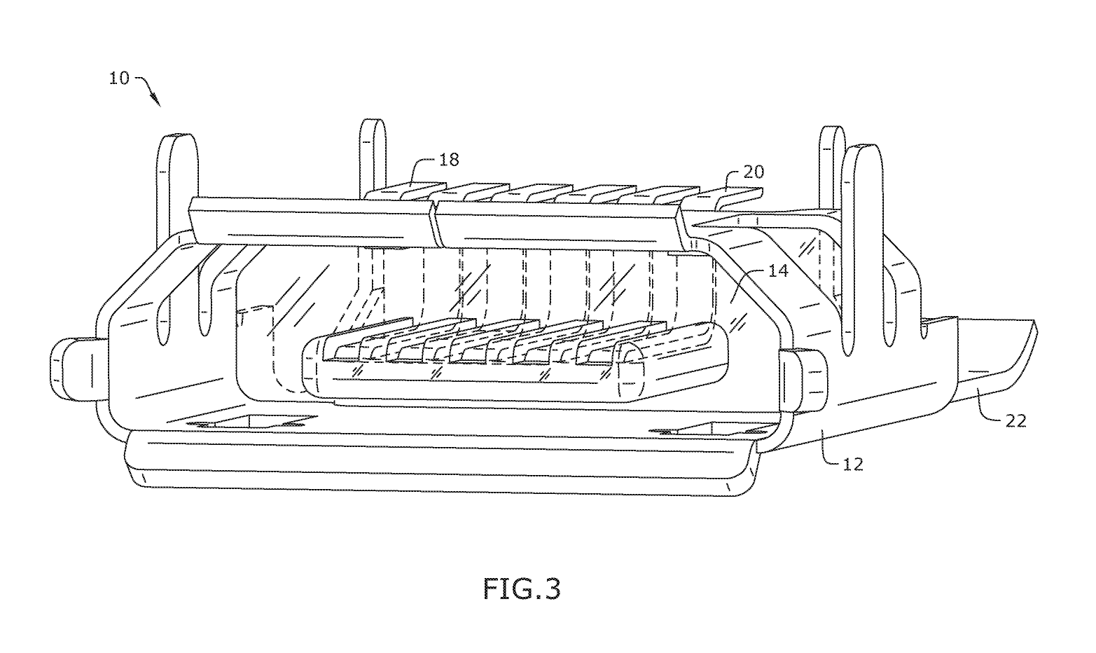

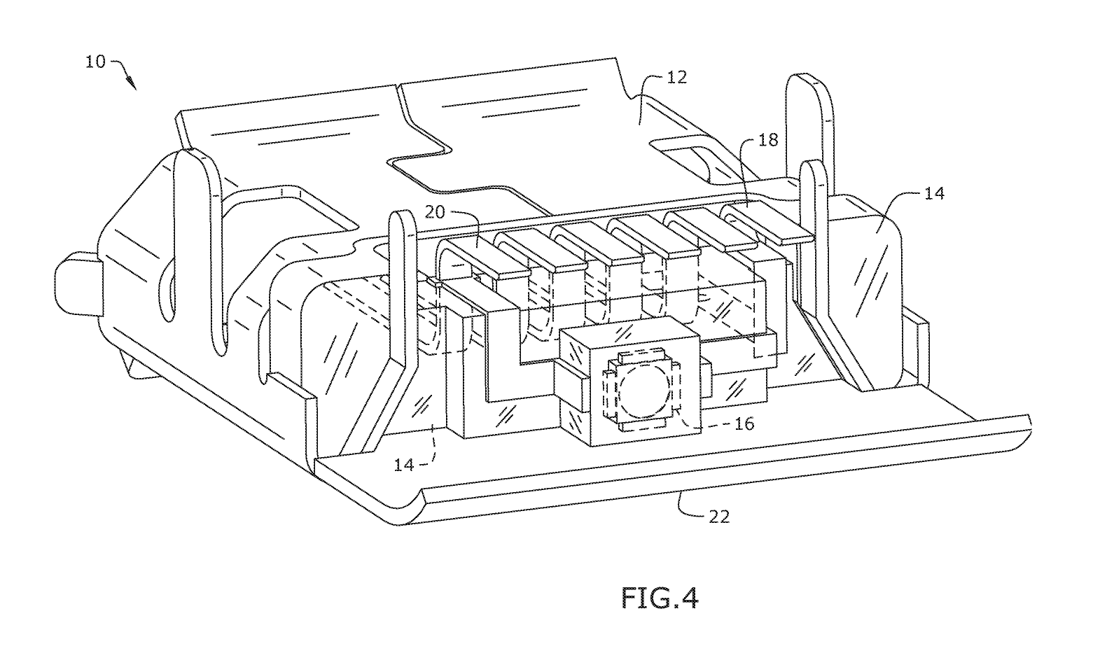

In some embodiments, a translucent or transparent casing 14 may encase the light source 16. In an exemplary embodiment, the casing 14 is translucent or transparent light reactive polymer that produces photoluminescence by excitation of the light from the light source 16. As may be appreciated, the photoluminescence creates a soft glow which may be beneficial in low light settings. The casing 14 may project toward the entry of the socket housing 12. Some embodiments may project the casing 14 proximate the set of USB connector pins. For example, the casing 14 may include a flange positioned at least partially below the set of USB connector pins. The flange may be an integrated part of the substrate supporting the USB connector pins thus providing a compatible connection with the male plug 26 (FIG. 2). Such a configuration avoids interference with the connection while illuminating the set of USB connector pins for improved visibility during connection. Referring to FIGS. 3 and 4, some embodiments may include a shroud 22 coupled to the rear of the socket housing 12. The shroud 22 may extend rearward and may include an upward curve to block light leakage from the light source 16 into the interior of electrical device host (not shown).

Persons of ordinary skill in the art may appreciate that numerous design configurations may be possible to enjoy the functional benefits of the inventive systems. Thus, given the wide variety of configurations and arrangements of embodiments of the present invention the scope of the present invention is reflected by the breadth of the claims below rather than narrowed by the embodiments described above. For example, while the socket 10 was described in the context of a female port, it will be understood that the socket 10 may be modified to operate as a male port in a USB connection.

What is claimed is:

1. A universal serial bus (USB) socket, comprising:
a socket housing configured to fit within a USB port;
a set of USB connector pins mounted to the socket housing;
a light source coupled to the socket housing and disposed to project light around a periphery of the set of USB connector pins; and
an electrical lead connected to the light source, the electrical lead for connection to a power source.

2. The USB socket of claim 1, further comprising a translucent or transparent casing encasing the light source.

3. The USB socket of claim 2, wherein the casing projects toward an entry of the socket housing and is positioned at least partially below the set of USB connector pins.

4. The USB socket of claim 2, wherein the translucent or transparent casing is a light reactive polymer.

5. The USB socket of claim 1, wherein the light source is a light emitting diode positioned rearward of the set of USB connector pins and opposite an entry of the socket housing.

6. The USB socket of claim 1, wherein the electrical lead is connected to a pin-out of the set of USB connector pins.

7. The USB socket of claim 1, further comprising a shroud coupled to a rear of the socket housing and disposed to block light from the light source from leaking rearward of the socket housing.

8. A universal serial bus (USB) socket, comprising:
a female socket housing configured to fit within a USB port;
a set of USB connector pins mounted to the female socket housing;
an LED coupled to the female socket housing and disposed to project light around a periphery of the set of USB connector pins;
a translucent or transparent light reactive polymer casing encasing the LED, wherein the casing projects toward an entry of the socket housing and is positioned at least partially below the set of USB connector pins; and
an electrical lead connected to the LED and connected to a pin-out of the set of USB connector pins, the electrical lead for connection to a power source.
